(19) United States
(12) Patent Application Publication
(10) Pub. No.: US 2026/0004604 A1
(43) Pub. Date: Jan. 1, 2026

(54) DOCUMENT EXTRACTION AND VALIDATION WITH AUTOMATED AND SELECTIVE HUMAN REVIEW

(71) Applicant: Carvana IPHC, LLC, Tempe, AZ (US)

(72) Inventors: Cameron Sheikholeslami, Tempe, AZ (US); Mikhail Semeniuk, Tempe, AZ (US); Paul McReynolds, Tempe, AZ (US)

(21) Appl. No.: 18/759,177

(22) Filed: Jun. 28, 2024

(51) Int. Cl. G06V 30/413; G06V 30/18

(52) U.S. Cl. CPC G06V 30/413; G06V 30/18

(57) ABSTRACT

Document extraction and verification involves receiving a request for an order of an order type and providing a user interface configured to receive documents, wherein the user interface indicates one or more predefined document types based on the order type. In response to receiving one or more submitted documents via the user interface, the documents are applied to a classification engine to obtain a classification for each of the one or more submitted documents. If the classification for each document satisfies predefined document types, the documents are applied to an extraction engine to obtain data segments, which can be used to generate the order.

### BACKGROUND

The performance and capabilities of document-understanding algorithms has rapidly evolved in the last few years. This includes the accuracy of optical character recognition (OCR) and the ability to extract specific fields using large language models (LLMs) and multimodal large language models (MLLMs). At the same time, the need for document review has dramatically increased. These documents are traditionally human reviewed, and data is manually extracted, with the accuracy very important to prevent any issues of fraud, problems with title changes in the context of an automotive transaction, or other complications that can occur if done improperly. What is needed is an improved technique for automated document review and verification.

### BRIEF DESCRIPTION OF THE DRAWINGS

For a detailed description of various examples, reference will now be made to the accompanying drawings in which:

FIG. 1 shows an example network environment in which embodiments described herein may be performed, in accordance with one or more embodiments;

FIG. 2 shows a flowchart of an intelligent technique for generating an order, in accordance with one or more embodiments;

FIG. 3 shows a flowchart of a technique for intelligent document classification, according to one or more embodiments;

FIG. 4 shows a flowchart of a technique for intelligent data extraction, according to one or more embodiments;

FIG. 5 shows an example flow diagram of a technique for partially automated order generation for vehicle transactions, according to one or more embodiments; and

FIG. 6 shows an example network diagram in accordance with the disclosed embodiments.

### DETAILED DESCRIPTION

The following description relates to technical improvements to generating electronic orders requiring data from multiple documents. In particular, techniques described herein are directed to techniques for providing a user interface to request documents from a user for a requested order or transaction. The documents received can be classified based on a machine learning model. The classification can be verified by a verification model. If the documents fail to be classified, or the classification fails, then the technique involves providing the documents for manual review, the results of which can be fed back into the classification model for retraining. The classified documents can be used to extract data, for example, by an extraction model. If data is unable to be extracted from the classified documents, then the technique involves providing the documents for manual extraction, the results of which can be fed back into the extraction model for retraining. The extracted data can then be used to generate the order.

In some embodiments, the various models may be specific to a particular order, or may be specific to particular characteristics of the order, such as order type, user location, or the like. For example, different models may be trained to handle orders for different jurisdictions based on differing requirements or regulations. In some embodiments, different extraction models may be used for different classifications. For example, once a document is classified, a corresponding extraction model may be selected.

The combination of automatic processing with human review allows for the quick real-time accepting or rejecting of documents that clearly pass or fail the requirements rules. The inclusion of human review for documents that are less certain removes the burden on the customer if the document is good and provides a feedback loop back into the model training that identifies documents to include for retraining.

Techniques described herein are useful in many industries. For example, when a customer is buying and/or financing a car online, the customer may be required to provide digital versions of certain documents, such as driver's license, proof of insurance, bank statements, and the like. These documents then need to be reviewed for specific data points that are unique to the document. For example, the insurance card needs to identify the starting and ending dates of the coverage as well as the coverage, including the vehicle being purchased. When a customer is selling their vehicle online, the customer may need to provide copies of their title to show proof of ownership. This title information may also be required when updating registration.

All of these documents vary company by company and state by state, with rules changing over time. This leads to human error when approving and/or rejecting these documents, and it causes this to be a very time-consuming process that can lead to issues with buying or selling the car if done improperly. To that end, the improvements described herein provide an enhanced technique to manage order generation by automating the entry and review of documents through multiple task-driven machine learning models. As a result, the process of generating an order becomes more efficient and reliable. From a technical perspective, the use of multiple, specially trained models allows for a lightweight technique for automatic document classification and data extraction, while also allowing the process to remain flexible for user review and changing rules and regulations.

In the following description, numerous specific details are set forth to provide a thorough understanding of the various techniques. As part of this description, some of the drawings represent structures and devices in block diagram form. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be omitted, or the components may be performed in a different order or even concurrently. In addition, other embodiments may include additional steps not depicted as part of the flow diagram. Further, the various steps may be described as being performed by particular modules or components. It should be understood that the language used in this disclosure has been principally selected for readability and instructional purposes and may not have been selected to delineate or circumscribe the disclosed subject matter. As such, the various processes may be performed by alternate components than the ones described.

Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

### System and Process for Order Generation

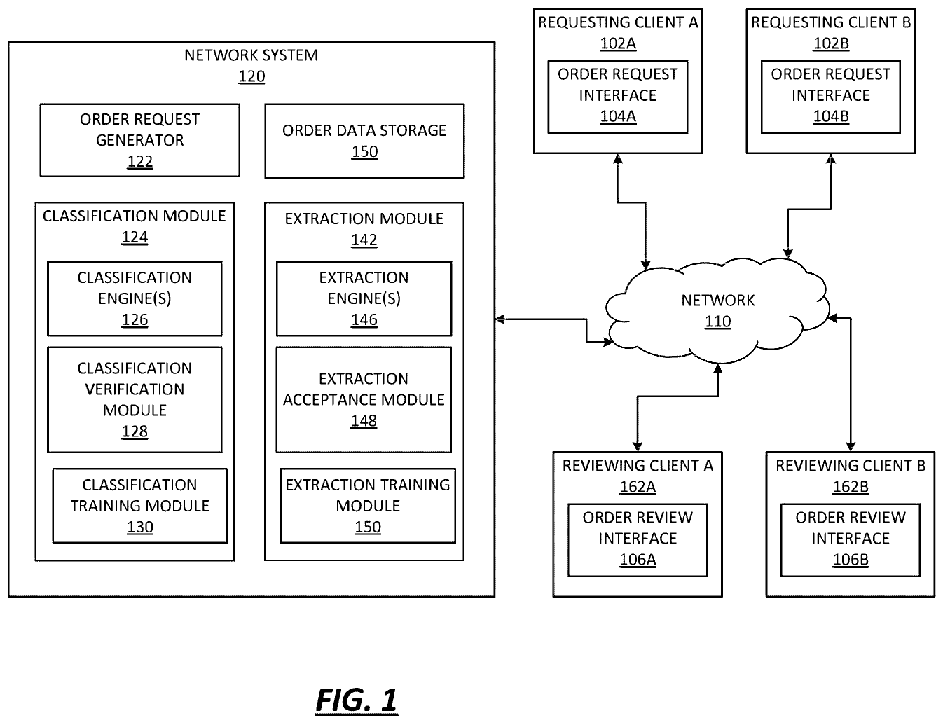

FIG. 1 shows a network diagram of an environment in which various embodiments described herein may be practiced. Techniques described herein describe a technique for incorporating machine learning (ML) tools in the form of trained networks for intelligent order generation. The network diagram includes multiple client devices, such as requesting client A 102A, requesting client B 102B, reviewing client A 162A, and reviewing client B 162B, communicably connected to a network system 120 across a network 110. Illustrative networks include, but are not limited to, a local network such as a universal serial bus (USB) network, an organization's local area network, a wide area network such as the Internet, or some combination thereof. Although a particular representation of components and modules is presented, it should be understood that in some embodiments, the various components and modules may be differently distributed among the devices pictured, or across additional devices not shown.

Requesting clients 102A and 102B may each be computing devices from which an order form may be accessed, and order information may be provided. Each of requesting clients 102A and 102B may be a same or different electronic device, such as a laptop, desktop computer, tablet, mobile device, smart device, or another electronic device having network connectivity from which an order can be requested and/or documents for an order can be provided. In one or more embodiments, requesting client A 102A may include order request interface 104A, which may be a computer application running on requesting client A 102A, and/or presented on requesting client A 102A (for example, if the application is hosted remotely, such as by network system 120). Order request interface 104A and order request interface 104B may include user input components to allow a user to request an order and/or provide documents for a requested order. In some embodiments, order request interface 104A may differ from order request interface 104B based on the capabilities of the corresponding electronic devices. Further, a single user can use multiple requesting clients for a single order request, for example, by using a desktop and a mobile device to request and upload documents. In an example in the automotive industry, the order request interface 104A and order request interface 104B may comprise a platform where customers can select a vehicle for purchase and input details about the purchase, such as whether they are buying with cash or financing, details around financing, personal details, and the like. In some embodiments, the order request interface 104 may additionally be used to provide user input to guide or enhance the automated process for generating the order. For example, if a document cannot be classified by the network system 120, the order request interface 104A may provide user input components to allow a user to override the classification decision, or the rejection decision. The user may be one or more human participants in a given transaction, such as a buyer, a seller, or another agent or person reviewing the documents on behalf of a party to the transaction.

Reviewing clients 162A and 162B may each be computing devices from which an order's information may be reviewed. Each of reviewing clients 162A and 162B may be a same or different electronic device, such as a laptop, desktop computer, tablet, mobile device, smart device, or another electronic device having network connectivity from which document classification can be reviewed, and/or data can be extracted. In one or more embodiments, reviewing client 162A may include an order review interface 106A, which may be a computer application running on reviewing client A 162A, and/or presented on reviewing client A 162A (for example, if the application is hosted remotely, such as by network system 120). Order review interface 106A and order review interface 106B may include user input components to allow a user to receive and review order generation data, such as documents along with their automated and/or manual classification, order data fields, and the like. In some embodiments, order review interface 106A may differ from order review interface 106B based on the capabilities of the corresponding electronic devices.

Network system 120 includes multiple components for supporting intelligent order generation. Network system 120 may be comprised of one or more network devices, such as computing devices, servers, network storage, and the like. The various modules described with respect to network system 120 may therefore be hosted on a single device or may be distributed across multiple devices within the network system 120. According to one or more embodiments, network system 120 may include an order request generator module 122. The order request generator module 122 may include one or more computing modules which are configured to interact with the requesting clients and/or reviewing clients to capture order information. For example, a user at requesting client A 102A may request an order via order request interface 104A. According to one or more embodiments, the order request generator module 122 may receive the details about the customer order via the order request interface 104 and generate automated requests for additional documentation. According to one or more embodiments, the additional documentation needed may be based on predefined rule sets based on a particular customer, vehicle, transaction, or some combination thereof. For example, additional documents in a vehicle purchase may include proof of insurance, bank statements, utility bills, and the like. In some embodiments, the automated requests may be sent back to the requesting client 102 from which the order request was received, and slash one or more additional clients. For example, if a user sends the request from a desktop computer, the automated request for the additional documents may be sent to additional devices, such as a mobile device or the like. In some involvements, the automated requests may be sent via SMS message, e-mail, or the like, and may include a web link to an online dashboard, or the like. Accordingly, a user may provide documents or other order information from one or more devices.

Network system 120 includes the classification module 124. Classification module 124 may be one or more computer program modules configured to receive documents and provide classification information for the documents, such as a classification and a confidence value for the classification. The classification module 124 may be comprised of a single module configured to receive the documents and provide the classification data or may be comprised of multiple individual modules. For example, as shown in FIG. 1, classification module 124 includes classification engine(s) 126, classification verification module 128, and classification training module 130. The various components of the classification module 124 may be hosted on a single device, or across multiple devices, such as in a cloud computing format.

Classification engine(s) 126 includes one or more machine learning models configured to classify documents being uploaded by a user. The classification engine(s) 126 may be individually trained for particular circumstances. For example, different classification engines may be used for different jurisdictions in order to provide more efficient models based on user data. For example, if a user is in the state of Texas, different documents may be used than if the user is in the state of Arizona. Thus, by providing a state-specific classification engine, the model may be more specifically trained for state-specific documents and state-specific requirements. As another example, different classification engines 126 may be used for different transactions. For example, a classification engine may be trained specifically for vehicle purchases, whereas a second classification engine may be trained specifically for vehicle financing. Accordingly, a classification engine for vehicle purchases may be trained on documents used to purchase a vehicle, such as user identification, insurance, and the like, whereas the model trained for vehicle financing may be trained based on bank statements, credit reports, and the like. Thus, in some embodiments, the classification engine used for a particular document may be selected by the order request generator module 122, upon determining a type of order being generated. The classification engine may be configured to ingest an uploaded document, and provide a document classification, as well as a confidence value for the classification.

Classification verification module 128 may be configured to ingest the document classification and the confidence value from classification engine(s) 126 to determine whether or not to accept the document. In some embodiments, the classification verification module 128 may be a trained model, a set of heuristics such as a rule set, or the like. The classification verification module 128 may compare the confidence value for a particular classification against a predefined or dynamic threshold value to determine whether to accept the uploaded document. For example, the threshold value may be tuned based on various factors, such as the type of document being uploaded, an override frequency for the classification, and the like. According to some embodiments, if a document fails classification verification, then the classification verification module 128 alerts the order request generator module 122, and a notice is provided to a user at the requesting client 102. From there, as described above, the user can use the order request interface to override the decision, reclassify the document, and slash or upload supplemental or replacement documents.

Classification training module 130 is configured to train and retrain the classification engine(s) 126. According to one or more embodiments, the classification training module 130 may be trained to classify documents for use in orders. In some embodiments, classification training module 130 may train multiple classification engine(s) 126 for specific tasks for specific contexts. The process for training the classification engine(s) 126 may include training a machine learning model based on manually classified or verified documents for different transactions. For example, a classification engine 126 may be trained specifically for vehicle purchases, whereas a second classification engine 126 may be trained specifically for vehicle financing. Accordingly, a classification engine 126 for vehicle purchases may be trained on documents used to purchase a vehicle, such as user identification, insurance, and the like, whereas the model trained for vehicle financing may be trained based on bank statements, credit reports, and the like. In some embodiments, the classification training module 130 may use prior order information, for example, from order data storage 150. In some embodiments, the training data may be preprocessed to remove personal identifying information or other sensitive information prior to training the models. Further, classification training module 130 may use manual feedback to retrain the classification engine(s) 126, such as the results of human review from reviewing client A 162A or reviewing client B 162B, or customer override from requesting client A 102A or requesting client B 102B.

The network system 120 also includes extraction module 142. Extraction module 142 may be one or more computer program modules configured to extract data from received documents and provide a determination as to whether the extracted data should be accepted for the order. The extraction module 142 may be comprised of a single module configured to receive classification data, such as a document, document classification and/or confidence value, and provide extracted data for generating an order, or may be comprised of multiple individual modules. For example, as shown in FIG. 1, extraction module 142 includes extraction engine(s) 146, extraction acceptance module 148, and extraction training module 150. The various components of the extraction module 142 may be hosted on a single device, or across multiple devices, such as in a cloud computing format.

Extraction engine(s) 146 includes one or more machine learning models configured to extract data from classified documents. The extraction engine(s) 126 may be individually trained for particular circumstances. For example, different classification engines may be used for different jurisdictions in order to provide more efficient models based on user data. For example, the data required in the state of Texas may differ from the data required in the state of Arizona. Thus, by providing a state-specific classification engine, the model may more efficiently extract requisite data from the documents. As another example, different extraction engine(s) 146 may be used for different document classifications. For example, a first extraction engine 146 may be trained specifically for extracting data from an insurance document, whereas a second extraction engine 146 may be trained specifically for extracting data from a bank statement. Thus, in some embodiments, the classification engine(s) 146 used for a particular document may be selected by the order request generator module 122, upon determining a type of order being generated, or based on the classification provided from the classification module 124. The extraction engine(s) 146 may be configured to ingest an uploaded document and document classification, and provide extracted data from the document. For example, the extraction engine(s) 146 may include one or more large language models configured to detect and extract data for predefined fields for a given task, such as an order type. In some embodiments, the extraction engine(s) 146 may additionally provide one or more confidence values for the document. For example, a confidence value may be generated for the document, indicating a confidence level that the expected data was able to be extracted from the document. As another example, a confidence value may be generated for each field, and may indicate a likelihood that the data extracted matches the field.

Extraction acceptance module 148 may be configured to ingest the extracted data and the confidence value(s) from extraction engine(s) 146, to determine whether or not to accept the document. In some embodiments, the extraction acceptance module 148 may be a trained model, a set of heuristics such as a rule set, or the like. The extraction acceptance module 148 may compare the confidence value for a particular field or document against a predefined or dynamic threshold value to determine whether to accept the data or document. Each document classification may have its own set of rules, and each field may be associated with a confidence threshold that can be tuned based on a variety of factors, such as the type of document being uploaded, a manual review waiting time, a frequency of manual rejection, and the like. If the document is accepted, the document request that triggered upload of the current document can be closed. If the document is rejected, the customer will be notified via the order request interface 104. In some embodiments, if the document is not confidently rejected or accepted, it can be queued for manual human review. For example, the document and extraction fields can be transmitted to reviewing client A 162A or reviewing client B 162B for manual review.

Extraction training module 150 is configured to train and retrain the extraction engine(s) 146. According to one or more embodiments, the extraction training module 150 may be trained to identify data from documents for various fields of an order. In some embodiments, extraction training module 150 may train multiple extraction engines 146 for specific tasks or specific contexts. The process for training the extraction engines 146 may include training a machine learning model based on manually extracted or verified documents or data from documents for different transactions. In some embodiments, the extraction training module 150 may use prior order information, for example, from order data storage 150. In some embodiments, the training data may be preprocessed to remove personal identifying information or other sensitive information prior to training the models. Further, extraction training module 150 may use manual feedback to retrain the extraction engine(s) 146, such as the results of human review from reviewing client A 162A or reviewing client B 162B.

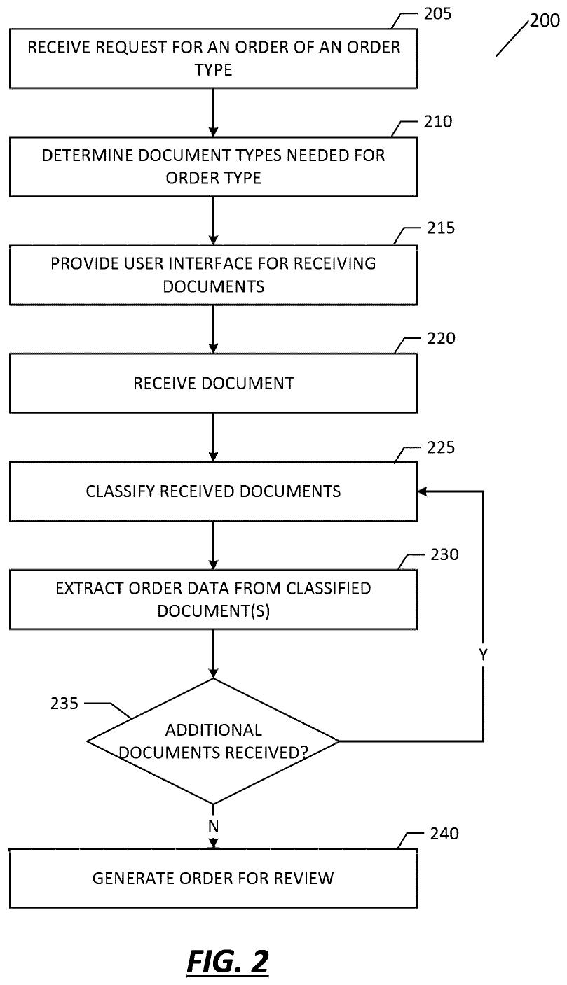

FIG. 2 shows a flowchart of an intelligent technique for generating an order, in accordance with one or more embodiments. In particular, FIG. 2 depicts an overall technique for at least partially automating an order process using specially trained models to guide the process. For purposes of explanation, the following steps will be described as being performed by particular components. However, it should be understood that the various actions may be performed by alternate components. In addition, the various actions may be performed in a different order. Further, some actions may be performed simultaneously, some may not be required, or others may be added.

The flowchart 200 begins at block 205, where a request is received for an order of a particular order type. The request may be received, for example, from a user using the user interface, such as an order request interface, from which a user may initiate a submission of an order, such as a set of information and documents which can be used by the receiving party to process a transaction. The request may be received by a back-end system, such as a server or other network device, configured to generate automatic order requests for the user, aggregate documents, and data from the user, and/or generate the order. In some embodiments, the request may be generated at the user's device, such as a client device, which may include a laptop, tablet, mobile device, smart device, or the like. The request may indicate or include initial information from which the order can be generated, such as an order type, initial user information, or the like.

The flowchart 200 proceeds to block 210, where the system determines document types needed for the order type. The determination may be based on the order type requested and/or additional contextual information, such as data already provided by the user, location or jurisdiction information associated with the user, or the like. In some embodiments, the document types may be determined based on required documents and/or required data for a particular order type, such as a particular transaction. Further, in some embodiments, the document types may be selected or retrieved from a predefined set of document types.

At block 215, the technique includes providing a user interface for receiving documents. The user interface may be provided in place of, or in addition to, an interface used to request the order at block 205. In some embodiments, the user interface may include an automated request for documents of the determinant document type, as in block 210. The user interface may be provided to the device from which the request was received. Additionally, or alternatively, the user interface may be provided at one or more additional devices. For example, an e-mail, text message, or the like may be sent to other devices associated with the user such that the user can use multiple devices to enter data and upload documents. This may be beneficial, for example, if a user has some documents on their personal computer, while others are stored on a mobile device. In some embodiments, the user interface may be (or include) a web link to a web page from which the data and documents may be entered or uploaded, respectively. Additionally, or alternatively, the user interface may be provided in different manners, such as an SMS message, an e-mail message, or the like. To that end, the request may be received in association with a user account or other identifying information from which the additional devices or communication means can be determined for providing the user interface.

The flowchart 200 proceeds to block 220, where the documents are received. The documents may be received one at a time, synchronously, or asynchronously. Further, the documents may be processed one at a time, or may be processed synchronously or asynchronously. For example, the user interface at block 215 may walk a user through a process by presenting one document request at a time. Each document request may correspond to documents of a particular classification or document, or may be for a general document on which data for the order may be found, or the like.

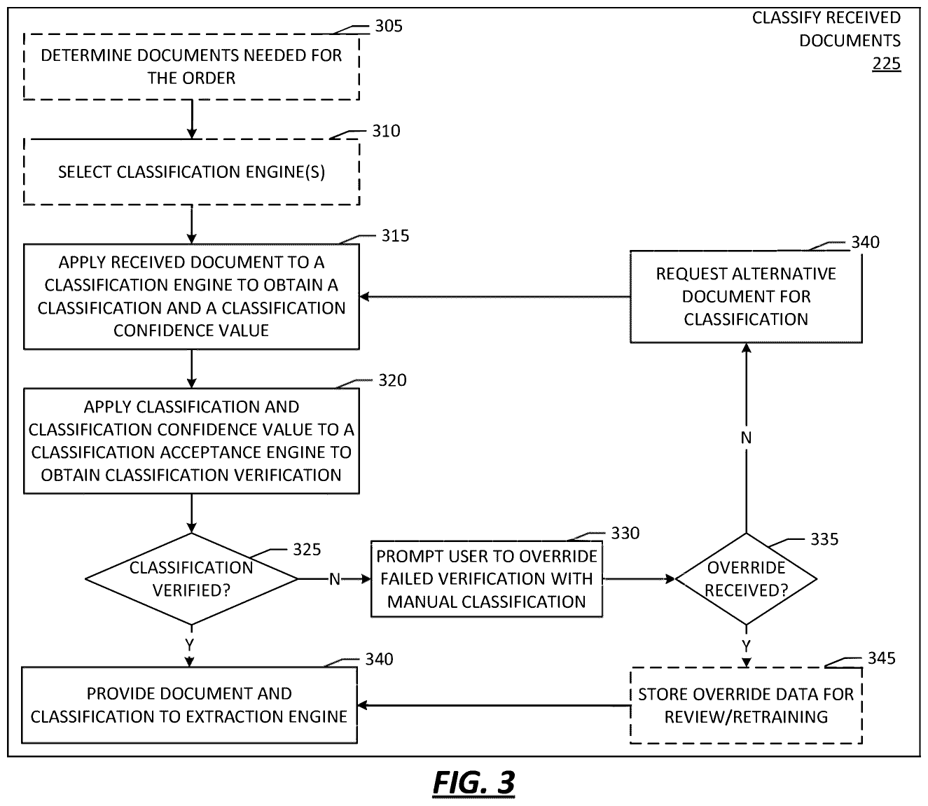

Processing the documents includes, at block 225, classifying the received documents. In some embodiments, classifying the received documents may include verifying that the document received matches a classification type associated with the user interface. Alternatively, a document may be received without an indication of the classification and may be processed to determine a classification type. In some embodiments, the classification may be performed by one or more machine learning models which are trained on documents used for transactions, such as the transactions that include the particular order type, or transactions more generally. In some embodiments, the classification model may be trained on documents used in a particular industry, or the like. According to one or more embodiments, the classification process may result in, for a particular document, a document classification, and a confidence value for the classification. The confidence value may indicate a likelihood that the classification is correct for the document. The classification process will be described in greater detail below with respect to FIG. 3.

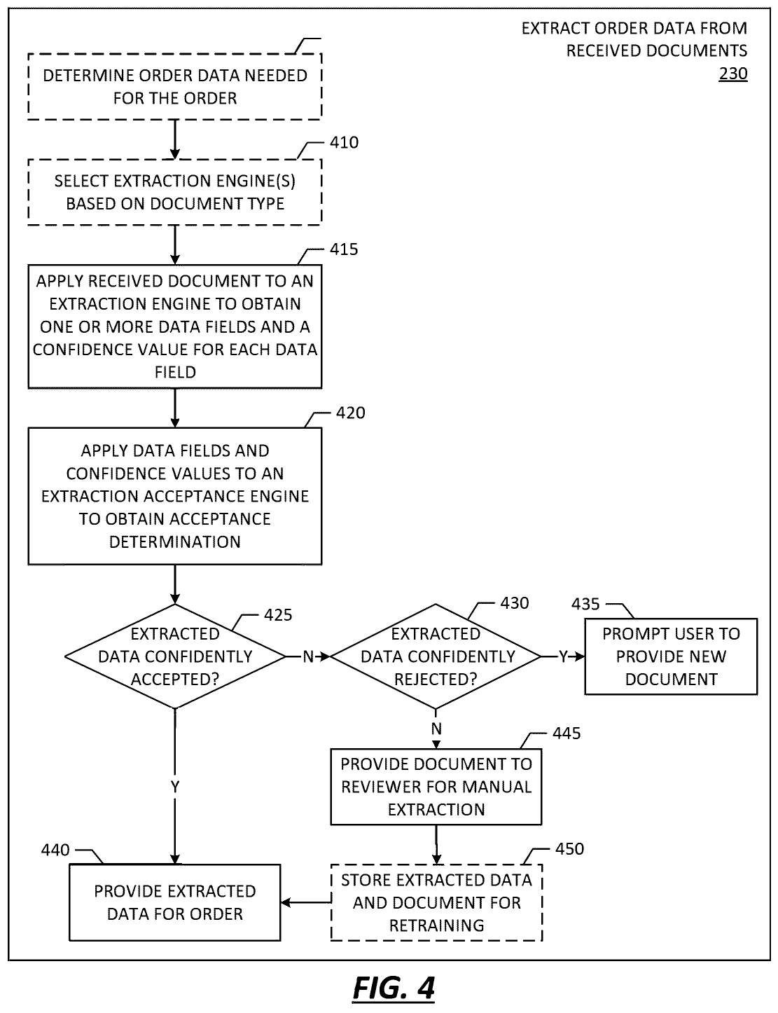

Once the document is classified, the flowchart proceeds to block 230, where order data is extracted from the classified document(s). According to our embodiments, order data may be extracted using one or more trained models configured to ingest classified documents along with their classification and identify data and the documents to be used for the requested order. The one or more models may be configured to extract predefined fields of data based on the order type. For example, a large language model may be used to scan the document, retrieve alphanumeric data from the document, and determine whether the alphanumeric data includes data for one or more fields of the order. In some embodiments, the model used to extract the order data may be specific to particular documents, such that a location of alphanumeric data on the document may be used to infer the type of data in the document. The extraction process will be described in greater detail below with respect to FIG. 4. According to some embodiments, the result of the extraction process may be one or more fields of data and, in some embodiments, a confidence value for the one or more fields of data.

The flowchart 200 proceeds to block 235, where a determination is made whether additional documents are received. In some embodiments, multiple documents may be received at the same time, but classified and extracted one at a time. Alternatively, the determination as to whether additional documents are received may include generating and providing a prompt to a user on a user interface requesting one or more additional documents of a same or different document type. The one or more additional documents requested may be based on order data which has been extracted and any remaining fields required for the particular order type. Additionally, as described below, additional documents may be received during the classification and/or extraction process if a document fails to be classified, or if data cannot be extracted from a particular document. If additional documents are received, then the flowchart returns to block 225, and the additional documents are classified and are used for data extraction, as described in block 230.

Returning to block 235, if a determination is made that no additional documents are received, then the flowchart concludes at block 240, where the determination may be made that no additional documents are received, for example, after a timeout and after the system has ceased generating automated document requests for the user, in response to user confirmation, or some combination thereof. At block 240, the order is generated for review. The generated order may be used for the particular transaction, either as is with the automated data, or may be provided to one or more humans for review. For example, the generated order may be provided to an entity facilitating the transaction associated with the order. For example, if the transaction is related to a vehicle purchase, the order may be provided to the seller of the vehicle to review the order. Additionally, or alternatively, the generated order may be provided back to the user providing the data, such as the customer, for confirmation.

### Document Classification

FIG. 3 shows a flowchart of a technique for intelligent document classification, according to one or more embodiments. In particular, FIG. 3 depicts an example technique for classifying a document using one or more trained models and optional human review, for example, as shown at block 225 of FIG. 2. For purposes of explanation, the following steps will be described as being performed by particular components. However, it should be understood that the various actions may be performed by alternate components. In addition, the various actions may be performed in a different order. Further, some actions may be performed simultaneously, some may not be required, or others may be added.

The flowchart begins at block 305 where, optionally, a determination is made as to the documents needed for the order. This determination may be made in addition to, or as an alternative to, the determination made at block 210 of FIG. 2, as described above. The flowchart also includes, at block 310, optionally selecting whatever classification engine(s). The one or more classification engines may be selected, for example, based on the order type, based on the prompt form which the document was received, or the like. In some embodiments, the classification engine(s) may be based on additional contextual clues, such as a location of the user, in order to provide location-specific classification of a document. The classification engine(s) may be individually trained for particular circumstances. For example, state-specific models may be used to identify state-issued identification documents, or the like.

The flowchart proceeds to block 315, where the received document is applied to a classification engine to obtain a classification and classification confidence value. In some embodiments, classifying the received documents may include verifying that the document received matches a classification type associated with the user interface. Alternatively, a document may be received without an indication of the classification and may be processed to determine a classification type. In some embodiments, the classification may be performed by one or more machine learning models which are trained on documents used for transactions, such as the particular order type, or orders more generally. The classification engine(s) may include one or more machine learning models configured to classify documents being uploaded by a user. The classification engine(s) may also include a model trained on training data that includes documents used in transactions that have been preclassified, or for whichever classification has been verified. For example, a neural network may be used, or any other kind of model configured to ingest a document, to provide a classification for the document. In some embodiments, the classification model may be trained on documents used in a particular industry, service type, or the like. In addition, the classification may be configured to provide a confidence value for the classification. In some embodiments, a single model may generate the classification and the confidence value. Alternatively, a separate technique may be used to determine the confidence value. For example, the confidence value may be determined as to the likelihood that the document could be classified by the classification engine(s). The confidence value may indicate a likelihood that the classification is correct for the document.

The flowchart proceeds to block 320, where the classification and classification confidence values are applied to an acceptance engine to obtain classification verification. For example, a classification verification module may be configured to ingest the document classification and the confidence value from the classification engine(s), to determine whether or not to accept the document. In some embodiments, the classification verification module may be a trained model, a set of heuristics such as a rule set, or the like. The classification verification module may compare the confidence value for the provided classification against a predefined or dynamic threshold value to determine whether to accept the uploaded document. For example, the threshold value may be tuned based on various factors, such as the type of document being uploaded, an override frequency for the classification, and the like.

A determination is made at block 325 as to whether the document classification is verified. The determination may be verified based on an acceptance or rejection from the classification verification at block 325. If the classification is verified, then the flowchart concludes at block 340, where the document and classification are provided to an extraction engine so that order data can be extracted from the document, as described with respect to block 230 of FIG. 2. The extraction process will be described in greater detail below with respect to FIG. 4.

According to embodiments, if a document fails classification verification at block 325, then the flowchart proceeds to block 330, and a notice is provided to a user of the failed classification verification. Said another way, if a document is unclassified, a user prompt will be triggered to request user input for a classification for the unclassified document. In some embodiments, a user interface may be provided to the user at one or more client devices, from which the user can override the decision to reject a classification from the classification engine, reclassify the document, and/or upload supplemental or replacement documents. Thus, the document, the classification, and/or the confidence value may be presented to the user at a client device. In some embodiments, the user may be a person at a requesting device, or a person at a receiving device. That is, the override prompt may be provided to a customer, or to a service provider, seller, or other party to the transaction.

The flowchart proceeds to block 335, where a determination is made as to whether an override is received. The override may be received, for example, if a user overrides the decision to reject a classification from the classification engine (thereby accepting an otherwise rejected classification from the classification), manually reclassifies the document, or the like. By contrast, an override may not be received if a user provides input indicating the override opportunity is rejected, if the user instead verifies that the classification should be rejected, or the like. As another example, if the override prompt is presented and no input is received for a predetermined time, such as a timeout period, then the override may be considered to be not received.

If, at block 335, a determination is made that the override is not received, then the flowchart returns to block 340, and a prompt may be sent to a user requesting an alternative document for classification. The prompt may be presented by a request interface at one or more client devices and may be presented along with a technical means for uploading the alternative document. In some embodiment, the alternative document may repeat the original request for the document in case the original request was misunderstood by the user, and/or may suggest an alternative document type which can be used in place of the rejected document. Upon receiving a new document, the classification process is repeated at block 315.

Returning to block 335, if override information is received, then optionally, the flowchart proceeds to block 345, where the override data, such as a user-specified classification, is stored for review and/or retraining. For example, the classification received in response to the override prompt may be stored along with the document and may be used to retrain the classification engine. In doing so, the user override may be used as a triggering event to create additional training data and/or retrain the classification engine.

The flowchart then concludes at block 340, where the document and classification are provided to an extraction engine so that order data can be extracted from the document, as described with respect to block 230 of FIG. 2. The extraction process will be described in greater detail below with respect to FIG. 4.

### Data Extraction

FIG. 4 shows a flowchart of a technique for intelligent data extraction, according to one or more embodiments. In particular, FIG. 4 depicts an example technique for extracting data from classified documents and optional human review, for example, as shown at block 230 of FIG. 2. For purposes of explanation, the following steps will be described as being performed by particular components. However, it should be understood that the various actions may be performed by alternate components. In addition, the various actions may be performed in a different order. Further, some actions may be performed simultaneously, some may not be required, or others may be added.

The flowchart begins at block 405 where, optionally, a determination is made as to the order data required for the order. This determination may be made in addition to, or as an alternative to, the determination made at block 210 of FIG. 2, as described above. The flowchart also includes, at block 410, optionally selecting one or more extraction engines. The one or more extraction engine(s) may be selected, for example, based on the classification for a particular document, based on the prompt form which the document was received, or the like. In some embodiments, the extraction engine(s) may be selected based on additional contextual clues, such as a location of the user, in order to provide location-specific classification of a document. The extraction engine(s) may be individually trained for particular circumstances. For example, state or region-specific models may be used to more efficiently extract data from state-specific documents, or the like.

The flowchart proceeds to block 415, where the received document is applied to an extraction engine to obtain a data segment for one or more data fields and associated confidence values. In some embodiments, extracting data from the received documents may include identifying predefined fields from a given document classification. For example, known document types may be associated with predefined fields. In some embodiments, the extraction may be performed by one or more machine learning models which are trained on documents used for transactions, such as the particular type of transaction, or transactions more generally, and may be specific to particular document types. The extraction engine may include one or more machine learning models configured to extract data segments from classified documents uploaded by a user. For example, at least part of the data in a data field may be captured as a data segment.

According to one or more embodiments, a confidence value can be determined for one or more of the data fields. In some embodiments, the confidence value may be a value indicating a percent confidence level for a particular field. As an alternative, a Boolean value may be returned indicating that a value for a particular field is either trustworthy or not trustworthy based on a confidence determination. For example, a field may be determined to be trustworthy if a confidence value is greater than a predefined threshold value. In some embodiments, the predefined threshold value may correspond to a confidence level associated with an expected human accuracy metric for data input for the field or document type. According to some embodiments, additional considerations may be used to determine whether a field is trustworthy. For example, a separate accuracy score may be determined based on the confidence of the character recognition used to pull the data in the field. The confidence threshold for the character recognition may be specific to a particular field or field type, or may be specific to a document type. In some embodiments, the trustworthiness value may be based on a combination of the field confidence value and the character recognition confidence value. For example, a threshold score for trustworthiness may be determined based on an optimization of an overall accuracy of the obtained values, and a proportion of documents which are considered to be trusted.

The flowchart proceeds to block 420, where the data fields and the confidence values are applied to an extraction acceptance engine to obtain an acceptance determination per field. According to one or more embodiments, the extraction acceptance engine determines whether to accept the document using the results from the document extraction component. Each document type may have different rules for acceptance. Further, each field may be associated with a different confidence threshold that can be tuned based on various factors. For example, the confidence threshold for a particular field may be tuned based on the type of document being uploaded, a backlog of human manual review, a frequency with which verified documents are being rejected by human manual review, and the like.

A determination is made at block 425 as to whether the extracted data is confidently accepted. The extracted data may be confidently accepted, for example, if the confidence value satisfies a first, highest threshold for each field. If the extracted data is confidently accepted, then the flowchart concludes at block 440, and the extracted data is provided for the order.

Returning to block 425, if the extracted data is not confidently accepted, then the flowchart proceeds to block 430, where determination is made as to whether the extracted data is confidently rejected. The extracted data may be confidently rejected, for example, if the confidence value satisfies a second, lowest threshold for each field. If the extracted data is confidently rejected, then the flowchart concludes at block 435, and a user prompt is generated to provide a new document.

Returning to block 430, if the extracted data is not confidently rejected, then the flowchart proceeds to block 445, and the document is provided to a reviewer for manual extraction. The extracted data may not be confidently rejected, for example, if the confidence values for at least some of the fields fall within the first threshold and second threshold. Optionally, at block 450, the extracted data from manual extraction and the document may be stored for retraining of the extraction engine. Then, the flowchart concludes at block 440, where the extracted data from manual extraction is provided for the order.

### Example Flow Diagram

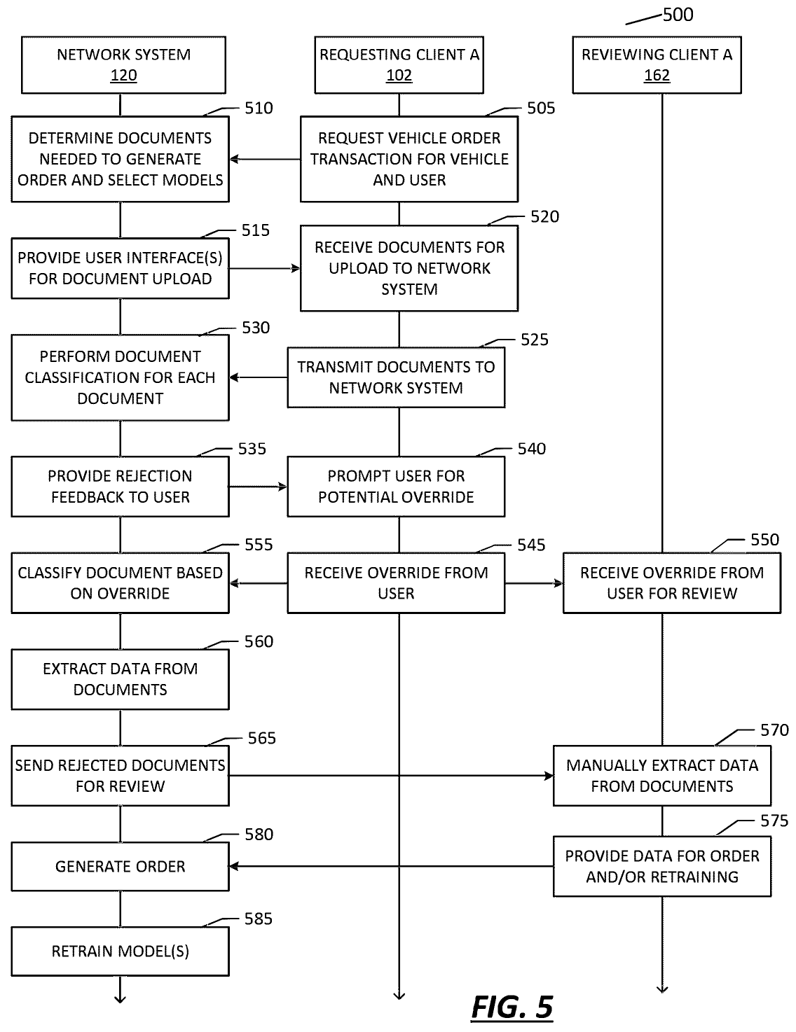

FIG. 5 shows an example flow diagram of a technique for partially automated order generation for vehicle-related transactions, according to one or more embodiments. In particular, FIG. 5 depicts an example workflow for automating order generation and review in the context of a vehicle order in the automotive industry. For purposes of explanation, the following steps will be described as being performed by particular components. However, it should be understood that the various actions may be performed by alternate components. In addition, the various actions may be performed in a different order. Further, some actions may be performed simultaneously, some may not be required, or others may be added.

The flow diagram 500 begins at block 505, where a request is generated at a requesting client A 102 for an order of a particular order type. In this example, the order type is a vehicle order transaction for a particular vehicle and user. The request may be received, for example, from a user using an order request interface at requesting client 102. The user interface may be provided locally at requesting client A 102, and/or may be provided across a network, for example, from network system 120. Requesting client A 102 may include, for example, a laptop, tablet, mobile device, smart device, or the like.

The flow diagram 500 proceeds to block 510, where the network system 120 receives the vehicle order request and determines document types needed for the order type. The determination may be based on the order type requested and/or additional contextual information, such as data already provided by the user, location or jurisdiction information associated with the user, or the like. In some embodiments, the document types may be determined based on required documents and/or required data for a particular order type. For example, in order to process a vehicle order transaction, required documents may include a driver's license, proof of insurance, and the like.

At block 515, the network system 120 provides a user interface for receiving documents to the requesting client A 102. The user interface may be provided in place of, or in addition to, an interface used to request the order at block 205 in FIG. 2. In some embodiments, the user interface may include an automated request for documents of the determined document type, as in block 210. The user interface may be provided to the device from which the request was received. Additionally, or alternatively, the user interface may be provided at one or more additional devices. For example, an e-mail, text message, or the like may be sent to other devices associated with the user such that the user can use multiple devices to enter data and upload documents. This may be beneficial, for example, if a user has some documents on their personal computer, while others are stored on a mobile device. In some embodiments, the user interface may be or include a web link to a web page from which the data and documents may be entered. Additionally, or alternatively, the user interface may be provided in different manners, such as an SMS message, an e-mail message, or the like. To that end, the request may be received in association with a user account or other identifying information from which the additional devices or communication means can be determined for providing the user interface.

The flow diagram 500 proceeds to block 520, where the documents are received from a user at the requesting client A 102. The documents may be received one at a time, or synchronously or asynchronously. Further, the documents may be processed one at a time, or may be processed synchronously or asynchronously. The requesting client A 102 may facilitate an upload process such that the requested documents are uploaded to network system 120, as shown at block 525.

Upon receiving the documents, the network system 120 may perform document classification for each document, as shown at block 530. In some embodiments, classifying the received documents may include verifying that the document received matches a classification type associated with the user interface. Alternatively, a document may be received without an indication of the classification and may be processed to determine a classification type. In some embodiments, the classification may be performed by one or more machine learning models which are trained on documents used for transactions, such as the particular order type, or that orders more generally. In some embodiments, the classification model may be trained to predict a classification based on documents used in a particular industry, or the like. According to one or more embodiments, the classification process may result in, for a particular document, a document classification, and a confidence value for the classification. The confidence value may indicate a likelihood that the classification is correct for the document.

According to some embodiments, if a document fails classification verification at block 530, then the flow diagram 500 proceeds to block 535, and a notice is provided to a user of the failed classification verification. Then, at block 540, a user interface may be provided to the user at one or more client devices, such as requesting client A 102, from which the user can override the decision to reject a classification from the classification engine, reclassify the document, and/or upload supplemental or replacement documents. In the example scenario of a vehicle purchase transaction, an insurance document may fail classification, for example, if the document is in a new format.

The flowchart proceeds to block 545, where a determination is made as to whether an override is received. The override may be received, for example, if a user overrides the decision to reject a classification from the classification engine (thereby accepting an otherwise rejected classification from the classification), manually reclassifies the document, or the like. In the example of a newly formatted insurance form, a user at requesting client A 102 may override the failed classification and instead provide a classification of a “Proof of Insurance” document.

According to some embodiments, the user override is sent to a reviewing client A 162A, thereby triggering a subsequent human review of the override and/or new classification. For example, at block 550, a reviewing client A 162A may receive the document, the new classification, and provide a determination as to whether the override is correct. In some embodiments, the document received by the reviewing client A 162A may be modified or scrubbed of personal identifying information. In some embodiments, the reviewing client A 162A may use the override information to retrain one or more of the classification models.

Once network system 120 receives the document classification from the requesting client A 102 and/or the reviewing client A 162A, then the flow diagram 500 proceeds to block 555, and the classification is applied to the document. Upon classifying the documents, data is extracted from the classified documents, as shown at block 560. According to one or more embodiments, order data may be extracted using one or more trained models configured to ingest classified documents along with their classification and identify data and the documents to be used for the requested order. The model(s) may be configured to extract predefined fields of data based on the order type. For example, a large language model may be used to scan the document, retrieve alphanumeric data from the document, and determine whether the alphanumeric data includes data for one or more fields of the order. In some embodiments, the model(s) used to extract the order data may be specific to particular documents, such that a location of alphanumeric data on the document may be used to infer the type of data in the document. For example, if the document is a Proof of Insurance document, one or more extraction models may be used to identify information such as name of insured, expiration date, and the like.

In some embodiments, documents which are rejected for data extraction are provided to a user for manual review, as shown at block 565. According to one or more embodiments, this may trigger a reviewing client A 162A to present a user interface in which a user can review and manually extract data from the document at block 570. Then, at block 575, the manually extracted data is provided to the network system 120.

The flow diagram 500 proceeds to block 580, where the order is generated. The generated order may be used for the particular transaction, either as is with the automated data, or may be provided to one or more humans for review. For example, the generated order may be provided to an entity facilitating the transaction associated with the order. For example, if the transaction is related to a vehicle purchase, the order may be provided to the seller of the vehicle to review the order. Additionally, or alternatively, the generated order may be provided back to the user providing the data, such as the customer, for confirmation. Further, in some embodiments, the documents that have been accepted may be appended to the order.

The flow diagram 500 concludes at block 585, where models are optionally retrained based on human review or intervention. For example, if a user overrode a classification decision, one or more classification engines may be retrained based on the customer override data. As another example, if data is manually extracted, a data extraction engine may be retrained based on the document and the manually extracted data.

### Example Electronic Device

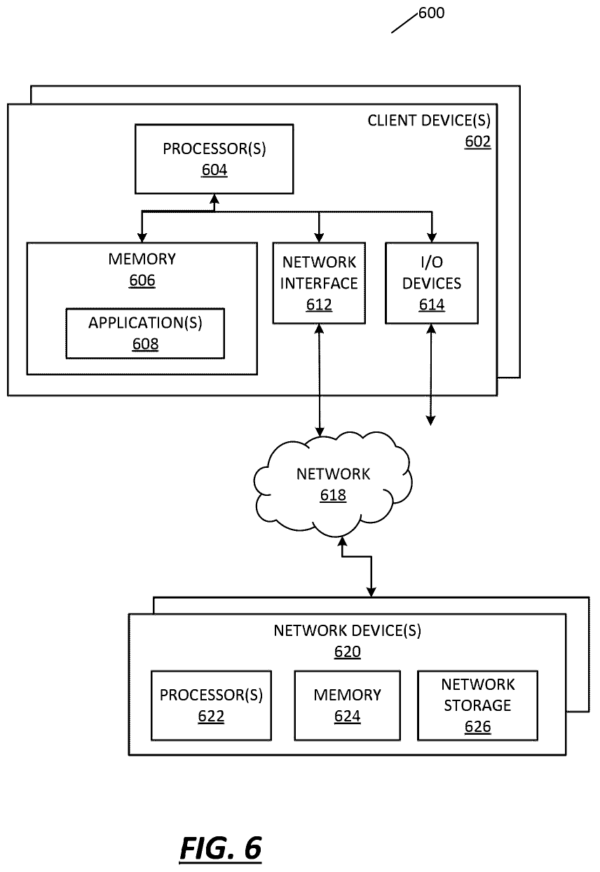

FIG. 6 shows an example of a hardware system for implementation of the intelligent order system in accordance with the disclosed embodiments. FIG. 6 depicts a network diagram 600, including one or more client devices 602 connected to one or more network devices 620 over a network 618. Client device(s) 602 may comprise a personal computer, a tablet device, a smart phone, network device, or any other electronic device which may be used to request an order or review order information. The network 618 may comprise one or more wired or wireless networks, wide area networks, local area networks, enterprise networks, short range networks, and the like. The client device(s) 602 can communicate with the one or more network devices 620 using various communication-based technologies, such as Wi-Fi, Bluetooth, cable connections, satellite, and the like. Users of the client device(s) 602 can interact with the network devices 620 to access services controlled and/or provided by the network devices 620.

Client device(s) 602 may include one or more processors 604. Processor(s) 604 may include multiple processors of the same or different type and may be configured to execute computer code or computer instructions, for example, computer readable code stored within memory 606. For example, the one or more processor(s) 604 may include one or more of a central processing unit (CPU), graphics processing unit (GPU), or other specialized processing hardware. In addition, each of the one or more processors may include one or more processing cores. Client device(s) 602 may also include a memory 606. Memory 606 may each include one or more different types of memory, which may be used for performing functions in conjunction with processor(s) 604. In addition, memory 606 can include one or more of transitory and/or non-transitory computer readable media. For example, memory 606 may include cache, ROM, RAM, or any kind of computer readable storage device capable of storing computer readable code. Memory 606 may store various programming modules and applications 608 for execution by processor(s) 604. Examples of memory 606 include magnetic disks, optical media such as CD-ROMs and digital video disks (DVDs), or semiconductor memory devices.

Client device(s) 602 also include a network interface 612 and I/O devices 614. The network interface 612 may be configured to allow data to be exchanged between client device(s) 602 and/or other devices coupled across the network 618. The network interface 612 may support communication via wired or wireless data networks. Input/output devices 614 may include one or more display devices, keyboards, keypads, touchpads, mice, scanning devices, voice or optical recognition devices, or any other devices suitable for entering or retrieving data by one or more client device(s) 602.

Network device(s) 620 may include similar components and functionality as those described in client device(s) 602. Network device(s) 620 may include, for example, one or more servers, network storage devices, additional client devices, and the like. Specifically, network device(s) 620 may include a memory 624, network storage 626, and/or one or more processors 622. The one or more processor(s) 622 can include, for example, one or more of a central processing unit (CPU), graphics processing unit (GPU), or other specialized processing hardware. In addition, each of the one or more processor(s) 622 may include one or more processing cores. Each of memory 624 and network storage 626 may include one or more of transitory and/or non-transitory computer readable media, such as magnetic disks, optical media such as CD-ROMs and digital video disks (DVDs), or semiconductor memory devices. While the various components are presented in a particular configuration across the various systems, it should be understood that the various modules and components may be differently distributed across the network.

According to some embodiments, limited user information may be used to perform techniques described herein. For example, limited personal information may be collected as required to generate orders at the request of the user. It should be understood that the privacy of individuals who use the intelligent order system and the Al tools described herein is protected under relevant privacy policies. In some embodiments, user information may be collected upon agreement of the end user to participate in such efforts in accordance with the relevant privacy policies.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

1. A non-transitory computer readable medium comprising computer readable code for document verification executable by one or more processors to:
receive a request for an order of an order type;
provide a user interface configured to receive documents, wherein the user interface indicates one or more predefined document types based on the order type; and
in response to receiving one or more submitted documents via the user interface:
apply the one or more submitted documents to a classification engine to obtain a classification for each of the one or more submitted documents,
determine whether classification for each of the one or more submitted documents satisfies at least one of the one or more predefined document types, and
in response to determining that each of the one or more submitted documents satisfies at least one of the one or more predefined document types:
apply the one or more submitted documents to an extraction engine to obtain data segments from the one or more submitted documents, and
generate the order using the obtained data segments.

2. The non-transitory computer readable medium of claim 1, wherein the classification engine is configured to provide a predicted classification and a confidence value for each document applied to the classification engine.

3. The non-transitory computer readable medium of claim 2, further comprising computer readable code to, in response to a determination that a particular document fails to satisfy a predetermined threshold:
provide, in the user interface, a notification that the particular document is unclassified, and a user input component for providing a user-specified classification for the particular document, and
in response to receiving the user-specified classification for the particular document, re-train the classification engine using the particular document and the user-specified classification.

4. The non-transitory computer readable medium of claim 1, further comprising computer readable code to:
apply the data segments from the one or more submitted documents to an extraction acceptance engine configured to validate each of the one or more submitted documents based on the data segments; and
in response to validating each of the one or more submitted documents, append the one or more submitted documents to the order.

5. The non-transitory computer readable medium of claim 1, wherein the computer readable code to apply the one or more submitted documents to an extraction engine to obtain the data segments from the one or more submitted documents further comprises computer readable code to:
select the extraction engine for each of the one or more submitted documents in accordance with a classification of the one or more submitted documents.

6. The non-transitory computer readable medium of claim 1, wherein the one or more predefined document types are determined based on a context of a user.

7. The non-transitory computer readable medium of claim 6, wherein the order corresponds to a vehicle-related transaction.

8. A method comprising:
receiving a request for an order of an order type;
providing a user interface configured to receive documents, wherein the user interface indicates one or more predefined document types based on the order type; and
in response to receiving one or more submitted documents via the user interface:
applying the one or more submitted documents to a classification engine to obtain a classification for each of the one or more submitted documents,
determining whether classification for each of the one or more submitted documents satisfies at least one of the one or more predefined document types, and
in response to determining that each of the one or more submitted documents satisfies at least one of the one or more predefined document types:
applying the one or more submitted documents to an extraction engine to obtain data segments from the one or more submitted documents, and
generating the order using the obtained data segments.

9. The method of claim 8, wherein the classification engine is configured to provide a predicted classification and a confidence value for each document applied to the classification engine.

10. The method of claim 9, further comprising, in response to a determination that a particular document fails to satisfy a predetermined threshold:
providing, in the user interface, a notification that the particular document is unclassified, and a user input component for providing a user-specified classification for the particular document, and
in response to receiving the user-specified classification for the particular document, re-training the classification engine using the particular document and the user-specified classification.

11. The method of claim 8, further comprising:
applying the data segments from the one or more submitted documents to an extraction acceptance engine configured to validate each of the one or more submitted documents based on the data segments; and
in response to validating each of the one or more submitted documents, appending the one or more submitted documents to the order.

12. The method of claim 8, wherein applying the one or more submitted documents to an extraction engine to obtain data segments from the one or more submitted documents further comprises:
selecting the extraction engine for each of the one or more submitted documents in accordance with a classification of the one or more submitted documents.

13. The method of claim 8, wherein the one or more predefined document types are determined based on a context of a user.

14. The method of claim 13, wherein the order corresponds to a vehicle-related transaction.

15. A system comprising:
one or more processors; and
one or more computer readable media comprising computer readable code executable by the one or more processors to:
receive a request for an order of an order type;
provide a user interface configured to receive documents, wherein the user interface indicates one or more predefined document types based on the order type; and
in response to receiving one or more submitted documents via the user interface:
apply the one or more submitted documents to a classification engine to obtain a classification for each of the one or more submitted documents,
determine whether classification for each of the one or more submitted documents satisfies at least one of the one or more predefined document types, and
in response to determining that each of the one or more submitted documents satisfies at least one of the one or more predefined document types:
apply the one or more submitted documents to an extraction engine to obtain data segments from the one or more submitted documents, and
generate the order using the obtained data segments.

16. The system of claim 15, wherein the classification engine is configured to provide a predicted classification and a confidence value for each document applied to the classification engine.

17. The system of claim 16, further comprising computer readable code to, in response to a determination that a particular document fails to satisfy a predetermined threshold:
provide, in the user interface, a notification that the particular document is unclassified, and a user input component for providing a user-specified classification for the particular document, and
in response to receiving the user-specified classification for the particular document, re-train the classification engine using the particular document and the user-specified classification.

18. The system of claim 15, further comprising computer readable code to:
apply the data segments from the one or more submitted documents to an extraction acceptance engine configured to validate each of the one or more submitted documents based on the data segments; and
in response to validating each of the one or more submitted documents, append the one or more submitted documents to the order.

19. The system of claim 15, wherein the computer readable code to apply the one or more submitted documents to an extraction engine to obtain data segments from the one or more submitted documents further comprises computer readable code to:
select the extraction engine for each of the one or more submitted documents in accordance with a classification of the one or more submitted documents.

20. The system of claim 15, wherein the one or more predefined document types are determined based on a context of a user.
